(19) United States
(12) Patent Application Publication
(10) Pub. No.: US 2003/0071456 A1
(43) Pub. Date: Apr. 17, 2003

(54) Method and apparatus for labeling perishable items

(76) Inventor: Jean Gervais, Cornwall (CA)

Correspondence Address: OGILVY RENAULT, 1981 MCGILL COLLEGE AVENUE, SUITE 1600, MONTREAL, QC, H3A2Y3, CA

(21) Appl. No.: 09/977,205

(22) Filed: Oct. 16, 2001

(51) Int. Cl. B42D 15/00

(52) U.S. Cl. 283/101

(57) ABSTRACT

Storage time of a perishable item in a perishable item storage system is tracked using a set of reusable labels with distinguishing features that associate each label with a distinct time unit. The distinguishing features are used to group labels, each group being associated with one of the time units. The labels permit a user to readily determine by visual inspection a time when a labeled item was added to the perishable item storage system. The time units may be days of the week.

### CROSS-REFERENCE TO RELATED APPLICATIONS

This is the first application filed for the present invention.

### MICROFICHE APPENDIX

Not applicable.

### TECHNICAL FIELD

The present invention relates in general to the tracking of perishable items, and in particular to a method and apparatus for labeling perishable items in order to facilitate determination of when individual perishable items were placed in storage.

### BACKGROUND OF THE INVENTION

Tracking how long a perishable item has been stored in a perishable item storage system is critical to many procedures in many industries such as pharmacology, and food services industries. It is also important to anyone who consumes perishable items that are stored in a refrigerator, for example. Many perishable products have labels showing expiration dates, but in many cases the labels are small, and not easily located or understood. Determining an expiry date of a perishable food item in a refrigerator requires finding the item in the refrigerator, removing the item, and manipulating the item so that the expiry date can be read. Furthermore, many perishable foods stored in a refrigerator do not have expiry dates, leftovers and unpackaged foods being prime examples. Difficulties in accurately and efficiently determining how long an item has been stored makes control of perishable items in storage systems difficult.

Many methods are known for reducing the time required to determine the length of time a perishable item has been stored in perishable item storage systems. One method involves manually and regularly updating a list of in-stock items. Other methods involve the use of electronic devices, such as timers that are attached to a refrigerator (or other storage container) and show an elapsed time since respective stored items were added, or a difference between a current time and an expiration time. Unfortunately such methods require the manual marking of stored items and maintenance of a detailed list.

For example, U.S. Pat. No. 5,487,276, entitled FOOD STORAGE TRACKING SYSTEM, which issued to Namisniak et al. on Jan. 27, 1998, discloses a method and apparatus for tracking perishable items in order to prevent the consumption of items after a safe storage time expires. A user manually maintains a list of items in the refrigerator, and uses color-coded food storage containers in a prescribed manner to facilitate the determination of a date on which the perishable item was stored. One embodiment of the storage tracking system includes a base unit with a microprocessor-controller for maintaining the list of stored items. Namisniak et al.'s system is expensive, time consuming, and requires that a user maintain an inventory of color-coded containers.

U.S. Pat. No. 5,969,606, entitled FOOD APPARATUS AND METHOD AND SYSTEM FOR MONITORING A FOOD ITEM, which issued to Rebel et al. on Oct. 19, 1998, describes a more sophisticated solution. Rebel et al. teach the use of containers with humidity sensors or other types of sensors (such as temperature, food quality, acidity etc.) having an electronic tag, a transmitter and an indicator. The system can track a storage time of food items. Although the system described by Rebel et al. is meritorious, it is an unduly complex and expensive system for monitoring a state of food items.

A simpler, less expensive solution for tracking a storage time of stored items is therefore desirable.

### SUMMARY OF THE INVENTION

It is therefore an object of the invention to provide a simple apparatus and method for enabling a user to determine when a perishable item was stored in a perishable item storage system.

Accordingly, an apparatus comprising a collection of labels is provided. The labels are grouped into at least two groups, and each group includes subgroups of time units. The labels are grouped and subgrouped according to distinguishing features they prominently display. The grouping and subgrouping of the labels permit a user to associate a time unit with any of the labels, with reference to a present time. Take, for example, two groups (red and white), which represent consecutive weeks. Each of the groups includes labels of seven types, which represent respective days of the week. There are therefore seven subgroups of each group, and the time units are days. Every label, by virtue of its distinguishing features, is associated with one and only one day. Consequently, on a Thursday of a red week, a label bearing the distinguishing features of a white Tuesday is understood to represent Tuesday of the previous week. A red Friday label (a label bearing the distinguishing features of the red group and Friday subgroup) is then understood to represent Friday of two weeks ago. In this manner the labels are used to identify a unique time unit at any moment in time, by virtue of the group and subgroup associated with the label by the distinguishing features the label bears.

In accordance with one aspect of the invention each of the labels bear one distinguishing feature that uniquely identifies the group of which it is a member, and a second distinguishing feature that uniquely identifies the subgroup of which it is a member. The distinguishing features are preferably bold and easily read, so that the unique time unit can be easily determined with a quick visual inspection of the label. Moreover, as the group is the more important indicator, preferably the distinguishing feature of the groups is more visually striking than the distinguishing features of the subgroups.

In accordance with the invention, a perishable item to be stored in the perishable item storage system is first labeled with a label associated with the time unit during which the item is placed in storage. It is preferable, for simplicity of use, that all of the time units have the same length, all of the groups are associated with equal intervals of time and that the time units of the subgroup collectively exhaust the intervals of time in the group, so that a period of the system can be defined as the number of subgroups times the number of groups. Preferably, the period of the system is at least as long as a shelf-life of any of the stored items. The number of labels in each subgroup is preferably adequate to label the number of perishable items that are likely to be stored during any given time unit.

In accordance with yet another aspect of the invention, the labels are removably affixable to the stored items of the perishable item storage system. Preferably, the label comprises a rear surface and a front surface. The rear surface of the label is removably affixable to a wide variety of surfaces, and the label is preferably repeatedly reusable. The label may therefore be made from a plastic sheet that adheres to other surfaces because of electrostatic cling. The front surface is preferably easy to clean, flat and prominently displays the distinguishing features of the group and subgroup.

In accordance with another aspect of the invention, the apparatus may further comprise a label storage surface to which the labels can be removably attached. The label storage surface preferably facilitates the storage and removal of the labels, and permits a user to readily identify how many labels of each type are in use.

Storing a perishable item begins with the selection of a label that represents a particular time unit during which the stored item is added to the perishable item storage system. The selected label is removed from the storage system and affixed to the perishable item, or a container in which the perishable item is placed. The item or the container is then placed in storage.

The storage time of a stored item is readily determined by visually inspecting the label affixed to the stored item. When a stored item is removed from the perishable item storage system, the label is removed from the stored item, and affixed to the label storage surface.

### BRIEF DESCRIPTION OF THE DRAWINGS

Further features and advantages of the present invention will become apparent from the following detailed description, taken in combination with the appended drawings, in which:

FIG. 1 schematically illustrates a label in accordance with the invention, the label being partially removed from a supporting surface;

FIG. 2 illustrates an exemplary set of labels for use in an embodiment of the invention having a two week period, some of the labels being in use;

FIG. 3 illustrates an exemplary use of the labels illustrated in FIG. 2 for tracking dates on which perishable food items were placed in storage;

FIG. 4 is a flow chart illustrating principal steps involved in storing a perishable item in accordance with the invention;

FIG. 5 is a flow chart illustrating principal steps involved in determining a storage date of a stored item in accordance with the present invention;

FIG. 6 is a flow chart illustrating principal steps involved in removing an item from storage, in accordance with the invention; and

FIG. 7 is a flow chart illustrating principal steps involved in removing stored items at the end of each time unit.

It should be noted that throughout the appended drawings, like features are identified by like reference numerals.

### DETAILED DESCRIPTION OF THE PREFERRED EMBODIMENT

The invention provides a method and apparatus for enabling a user to easily and rapidly determine when a perishable item was stored in a perishable item storage system.

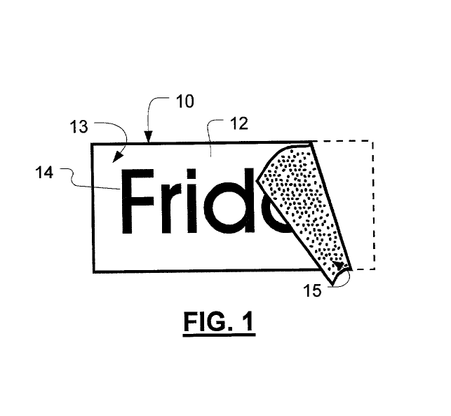

FIG. 1 illustrates a partially removed label 10 in accordance with the invention. Each label 10 bears two distinguishing features, for example, a background color 12, and a name 14 printed over the background color. The label 10 has a white background 12, and the name 14 is “Friday”. The background color 12 of the label 10 designates a group, which in this example is associated with a week. The name 14 designates a day of the week.

The label 10 has a front surface 13 bearing the distinguishing features, and a rear surface 15 adapted to be removably affixed to stored items. The label 10 is preferably a thin plastic sheet having electrostatic properties that enable it to cling to many surfaces, while being repeatedly reusable. The labels 10 are adapted to adhere to a variety of different types of materials. For example, the labels preferably adhere to glass, a variety of plastics, metals, etc.

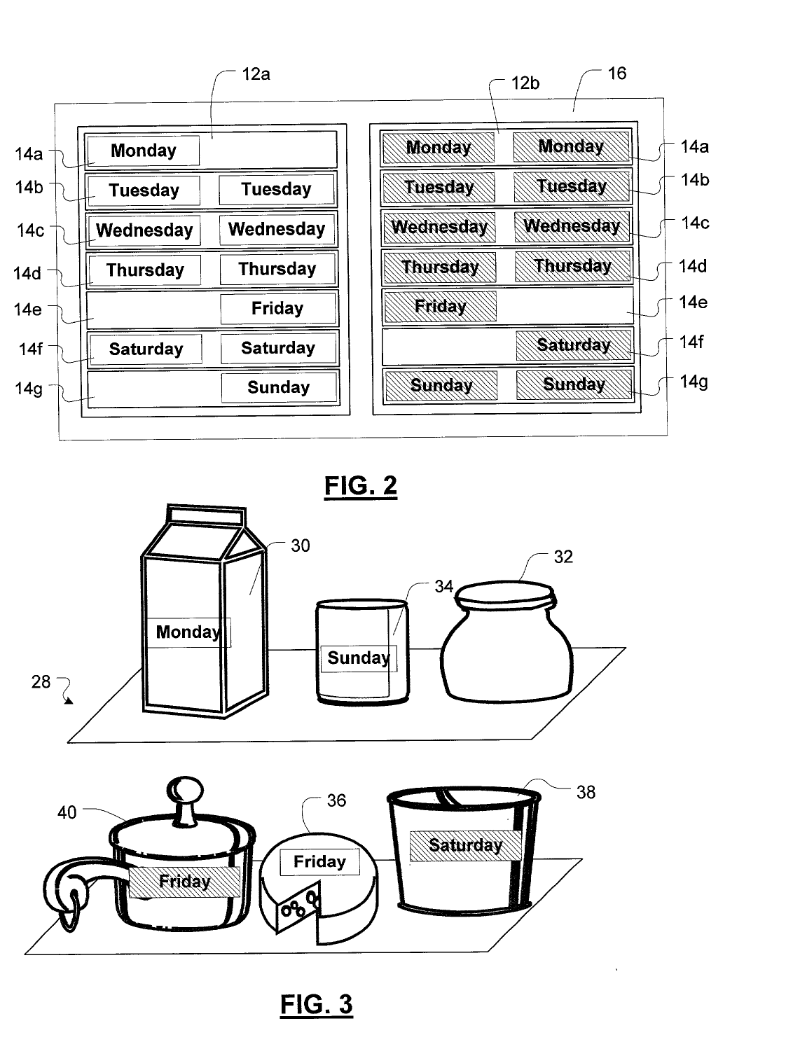

FIG. 2 illustrates an exemplary set of 23 of 28 labels 10 of the same format as the label 10 shown in FIG. 1. The embodiment shown in FIG. 2 is based on a labeling scheme with a period of 14 days. The distinguishing features of the labels 10 are respectively associated with weeks (label color) and days (label name). There is space for two of each of the 14 types of labels associated with the 14 days of the period. The labels 10 are removably attached to a label storage surface 16 adapted to store the 28 labels 10 in a manner that permits a user to rapidly assess a number and a storage time of items in storage. The labels 10 are arranged into groups (weeks 12a,b) by background color 12, and into subgroups (days 14a-g) by name 14. Each of the two weeks is represented by a respective color of the label, so the week with which a label is associated is easily recognized at a glance. The labels 10 of week 12a are white, for example, whereas the labels of week 12b are red. Each of the labels 10 prominently features a name 14 that designates the respective day of the week.

In the illustrated embodiment of the invention, each group includes labels for seven days, representing respective days of the week. A unique day in the period is therefore indicated by each label, which identifies both a week (color) and day of the week (name). In this example, two of the 28 labels 10 are associated with each day in the period, as it is assumed that not more than two items are to be stored on any given day. As will be understood by those skilled in the art, the number of labels supported by the storage surface 16 depends on an average number of items to be stored during each time unit.

Five labels 10 are conspicuously absent from the label storage surface 16 illustrated in FIG. 2. These labels 10 are in use, as illustrated in FIG. 3. The five labels are temporarily affixed to respective containers of tracked perishable food items in a refrigerator 28. As is illustrated, perishable food items 30, 32, 34, 36, 38, and 40 are all stored in the refrigerator 28. A respective label is affixed to each of the perishable food items 30-40 except for an item 32. Food items that have a storage time limit that exceeds one period (item 32) are not labeled. Furthermore, the labels may be selectively applied to only those stored items that are to be tracked, instead of all of the items stored in the perishable item storage system. The invention may apply only to certain stored items in a refrigerator; for example, leftovers, baby formula, or packaged items without expiry dates, etc. Although stored items may not all be tracked stored items, all references to a stored item that follow are intended to refer only to tracked stored items.

Given the example shown in FIG. 3, if the day is Friday of the red week 12b, then perishable food item 40 was stored today, perishable food item 38 was stored the Saturday before last, and perishable food items 30, 34 and 36 were stored on Monday, Sunday, and Friday of last week, respectively.

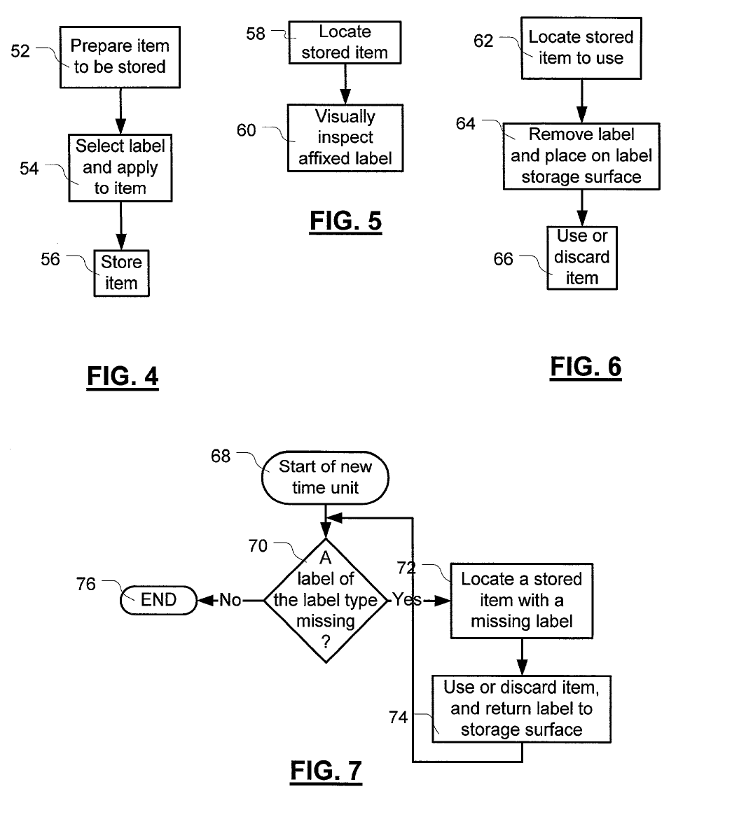

In accordance with the present invention, certain procedures are followed to maintain stored items in the refrigerator. These procedures are discussed below with reference to FIGS. 4-7.

FIG. 4 is a flow chart illustrating principal steps involved in storing a perishable item. The perishable item is prepared for storage (step 52). The time when the perishable item will be added to the perishable item storage system is chosen (generally the current time unit), a label associated with the chosen time unit is retrieved from the label storage surface 16, and the label is affixed to the perishable item (step 54). Finally, in step 56, the perishable item is added to the perishable item storage system.

FIG. 5 is a flow chart illustrating principal steps involved in determining when an item was placed in storage. The user locates the item in the perishable item storage system (step 58) and, in step 60, the user visually inspects the label affixed to the stored item. The distinguishing features borne on the label indicate a unique time unit when the item was stored.

FIG. 6 is a flow chart illustrating principal steps performed by a user when removing a stored item from the perishable item storage system. In step 62, the user locates the stored item in the perishable item storage system. The user then removes the temporarily affixed label from the stored item and places the label on the label storage surface 16 (step 64). In step 66 the user may consume or discard the stored item.

FIG. 7 is a flow chart illustrating principal steps involved in a procedure performed once during each time unit. This procedure may be performed at the beginning of every new time unit, or it may be performed at any of one or more times thereafter, provided it is completed before a perishable item is added to storage during that time unit.

In step 68, when a new time unit begins, an association between a label type and a time unit of one period ago expires. The label type therefore becomes associated with a current time unit. In step 70, the user determines if a label of the label type is absent from the label storage surface 16. If the user determines that one or more labels are missing, the user locates the item(s) bearing the one or more labels (step 72) in the perishable item storage system, and either uses or discards the stored item(s). The label(s) are then returned to the label storage surface 16 (step 74). Steps 70-74 are repeated until all of the current time unit's labels are replaced on the label storage surface 16. If the user determines in step 70 that none of the current time unit's labels are in use, the operation ends (step 76). It should also be noted that this operation serves to identify and remove perishable items having expired storage time limits.

The invention therefore provides a simple, inexpensive method and apparatus for tracking perishable stored items. The method is readily comprehended and does not require extensive skill or training. Although the method and apparatus have been explained with reference to the storage of items in a refrigerator, it will readily be understood by those skilled in the art that the invention is adapted to be used for tracking items in an industrial or experimental environment, and that the time units and system period may be adapted to an appropriate time frame.

The embodiments of this invention described above are therefore intended to be exemplary only, and the scope of the invention is intended to be limited solely by the scope of the appended claims.

I/We claim:

1. An apparatus for tracking a storage time of an item stored in a perishable item storage system, comprising a set of labels, each label being removably affixable to substantially any perishable item to be labeled and stored in the perishable item storage system, and each of the labels having a front surface that bears a first distinguishing feature designating membership in a group and a second distinguishing feature designating membership in a subgroup of time units in the group, each label's distinguishing features designating a unique time unit jointly identified by the group and subgroup.

2. An apparatus as claimed in claim 1, wherein the distinguishing features that the front surface of the label bears enables a user to determine by visual inspection the designated time unit, which corresponds to a time when a stored item to which the label is affixed was stored in the perishable item storage system.

3. An apparatus as claimed in claim 1, wherein the number of labels in each subgroup is equal to, or greater than, a number of perishable items that are expected to stored in the perishable item storage system during any given time unit.

4. An apparatus as claimed in claim 3, wherein the distinguishing features of a label designate a particular day of a week, and a particular week of a cycle, respectively; and, the duration of the cycle is a predefined number of weeks.

5. An apparatus as claimed in claim 1, wherein each of the labels comprises a rear surface that is removably adherent to a variety of mounting surfaces.

6. An apparatus as claimed in claim 5, wherein the labels are repeatedly reusable.

7. An apparatus as claimed in claim 6, wherein the labels are constructed of a static cling plastic material.

8. An apparatus as claimed in claim 1, further comprising a label storage surface, the labels being removably adherent to the label storage surface on which they are stored in a predefined arrangement organized in accordance with designated time units associated with the labels.

9. A method for tracking a storage time of stored items in a perishable item storage system, comprising steps of:
temporarily affixing to each item to be stored in the perishable item storage system, a label bearing a distinguishing feature that designates a time unit during which the respective perishable item is stored in the perishable item storage system, the label being removed from a label storage surface that stores a predefined number of labels;
determining when a perishable item was stored in the perishable item storage system by visual inspection of one of the labels affixed to the perishable item, and a label storage surface on which unused labels are stored;
removing stored items that have been stored for a duration of an entire cycle by removing the stored items from the perishable item storage system; and
removing the label from a stored item when removing the stored item from the perishable item storage system, and returning the label to the label storage surface.

10. A method as claimed in claim 9, wherein the step of selecting a label comprises a step of removing the label from a label storage surface.

11. A method as claimed in claim 10, wherein the perishable item storage system comprises a refrigerator, and the step of retrieving the label comprises a step of retrieving the label from the label storage surface, which is attached to an external surface of the refrigerator.

12. A method as claimed in claim 9, wherein the step of removing comprises steps of:
determining if one or more labels bearing the distinguishing features that designate a current time unit are missing from a label storage surface;
if there is at least one label missing, locating and removing stored items to which the at least one missing label is temporarily affixed; and
returning the at least one missing label to the label storage surface.
